(19) United States
(12) Patent Application Publication
(10) Pub. No.: US 2009/0123218 A1
(43) Pub. Date: May 14, 2009

(54) Digital Display Pen

(76) Inventor: Kyu Jin Kim, Fullerton, CA (US)

Correspondence Address: PARK LAW FIRM, 3255 WILSHIRE BLVD, SUITE 1110, LOS ANGELES, CA, 90010, US

(21) Appl. No.: 11/937,295

(22) Filed: Nov. 8, 2007

(51) Int. Cl. B43K 29/08; G06F 7/58

(52) U.S. Cl. 401/195; 708/250

(57) ABSTRACT

A digital display pen includes an elongate body, a display provided on the body, a processor that generates alphanumeric data that is displayed on the display and a switch device that starts and/or stops operation of the display. The elongate body includes a writing tip that is adapted to leave a colored line on a paper. The display has four modes, time, minutes, world clock and random number. In the random number mode, one or more numbers for lottery is generated by the processor, and the generated number is displayed by the display. The number for lottery includes a Mega number, a roulette number or a Lotto number.

### BACKGROUND OF THE INVENTION

The present invention relates to a digital display pen. More particularly, the present invention relates to a pen having a digital display that displays alphanumeric information that can be used for various purposes.

A pen is a very frequently used object in human life. A pen or writing instrument is one of most commonly carried item as personal belongings. It would be beneficial if a useful function is combined to such commonly carried item.

### SUMMARY OF THE INVENTION

The present invention is conceived to add a useful function to a writing instrument.

An objective of the invention is to provide a pen equipped with a digital display function.

Another objective of the invention is to provide a pen that displays alphanumeric information that can be applied in various fields.

In order to achieve the above objective, the present invention provides a digital display pen that includes an elongate body, a display provided on the body, a processor that generates alphanumeric data that is displayed on the display and a switch device that starts and/or stops operation of the display. The elongate body comprises a writing tip that is adapted to leave a colored line on a paper.

The elongate body further comprises a holding clip that is adapted to attach the digital display pen to a user's clothing. The switch device is provided on an end of the holding clip.

The cross section of the elongate body has a shape of a circle, an oval or a polygon. The polygon includes a triangle, a rectangle, a hexagon and an octagon.

The writing tip includes a tip of a fountain pen or a mechanical pencil tip.

The display comprises four modes, time, minutes, world clock and random number.

The switch device comprises a selection switch. The selection switch selects one of the four modes.

In the random number mode, one or more numbers for lottery is generated by the processor, and the generated number is displayed by the display.

The number for lottery comprises a Mega number, a roulette number or a Lotto number.

The elongate body further comprises a grip that prevents slipping of user's hand.

The advantages of the present invention are: (1) the pen greatly facilitates entertainment activity such as lottery or gambling with a handy and simple means; (2) the pen provides clock function so that a user can check time with least motion; and (3) the pen functions as a second clock that indicates world time.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is an elevation view showing a digital display pen that includes a single unit display;

FIG. 2 is an elevation view showing a digital display pen that includes a multi unit display;

FIG. 3 is an elevation view showing a digital display pen that displays random number for lottery; and

FIG. 4 is a schematic block diagram that shows electronic components of a digital display pen.

### DETAILED DESCRIPTION OF THE INVENTION

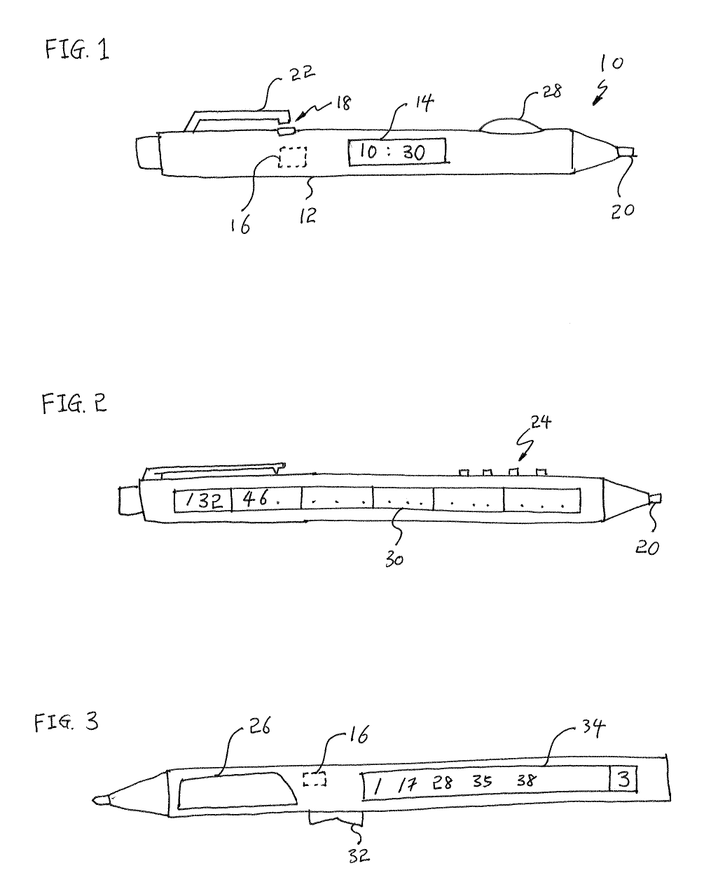

FIG. 1 shows a digital display pen 10 that includes an elongate body 12, a display 14 provided on the body 12, a processor 16 that generates alphanumeric data that is displayed on the display 14 and a switch device 18 that starts and/or stops operation of the display 14. The elongate body 12 comprises a writing tip 20 that is adapted to leave a colored line on a paper.

The elongate body 12 further comprises a holding clip 22 that is adapted to attach the digital display pen 10 to a user's clothing. The switch device 18 is provided on an end of the holding clip. Alternatively, the switch device 18 includes a button switch 28 that is provided near the writing tip 20.

The cross section of the elongate body 12 has a shape of a circle, an oval or a polygon. The polygon includes a triangle, a rectangle, a hexagon and an octagon.

The digital display pen 10 may be applied to various types of writing instrument. The writing tip 20 may be a tip of a fountain pen or a mechanical pencil tip.

The display 14 comprises four modes, time, minutes, world clock and random number.

FIG. 2 shows that the switch device 18 comprises a selection switch 24. The selection switch 24 selects one of the four modes.

In the random number mode, one or more numbers for lottery is generated by the processor 16, and the generated number is displayed by the single display 14 or a multi-unit display 30 shown in FIG. 2.

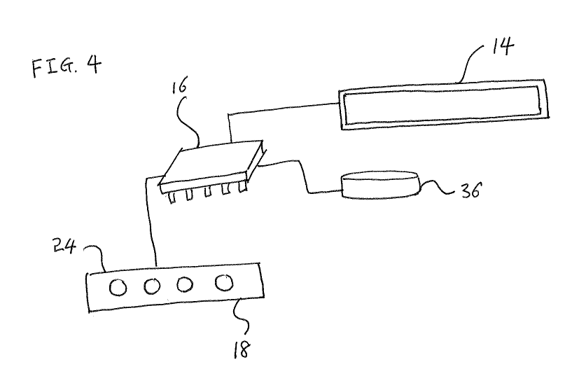

The number for lottery comprises a Mega number, a roulette number or a Lotto number. FIG. 3 shows an example that such number for lottery is displayed with a display 34. A selection switch 32 selects type of lottery.

The elongate body further comprises a grip 26 that prevents slipping of user's hand.

FIG. 4 shows electronic components for the digital display pen 10. A battery 36 provides power to the processor 16, which is an IC chip. The processor 16 is operated by user's selection with the switch device 18, and drives the display 14 so that the display 14 displays alphanumeric data that is generated by the processor 16.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A digital display pen comprising:
a) an elongate body;
b) a display provided on the body;
c) a processor that generates alphanumeric data that is displayed on the display; and
d) a switch device that starts and/or stops operation of the display;
wherein the elongate body comprises a writing tip that is adapted to leave a colored line on a paper.

2. The digital display pen of claim 1, wherein the elongate body further comprises a holding clip that is adapted to attach the digital display pen to a user's clothing, wherein the switch device is provided on an end of the holding clip.

3. The digital display pen of claim 1, wherein the cross section of the elongate body has a shape of a circle, an oval or a polygon, wherein the polygon includes a triangle, a rectangle, a hexagon and an octagon.

4. The digital display pen of claim 1, wherein the writing tip includes a tip of a fountain pen.

5. The digital display pen of claim 1, wherein the writing tip includes a mechanical pencil tip.

6. The digital display pen of claim 1, wherein the display comprises four modes, time, minutes, world clock and random number.

7. The digital display pen of claim 6, wherein the switch device comprises a selection switch, wherein the selection switch selects one of the four modes.

8. The digital display pen of claim 6, wherein in the random number mode, one or more numbers for lottery is generated by the processor, and the generated number is displayed by the display.

9. The digital display pen of claim 8, wherein the number for lottery comprises a Mega number.

10. The digital display pen of claim 8, wherein the number for lottery comprises a roulette number.

11. The digital display pen of claim 8, wherein the number for lottery comprises a Lotto number.

12. The digital display pen of claim 1, wherein the elongate body further comprises a grip that prevents slipping of user's hand.
